(19) United States
(12) Patent Application Publication
(10) Pub. No.: US 2015/0065612 A1
(43) Pub. Date: Mar. 5, 2015

(54) ELECTRICAL INSULATION BODY FOR A HIGH-VOLTAGE ROTARY MACHINE AND METHOD FOR PRODUCING THE ELECTRICAL INSULATION BODY

(71) Applicant: Siemens Aktiengesellschaft, Munich (DE)

(72) Inventors: Peter Groppel, Erlangen (DE); Christian Meichsner, Buttenheim (DE); Friedhelm Pohlmann, Essen (DE)

(73) Assignee: Siemens Aktiengesellschaft, Munich (DE)

(21) Appl. No.: 14/388,656

(22) PCT Filed: Feb. 1, 2013
(86) PCT No.: PCT/EP2013/052049

§ 371 Date: Sep. 29, 2014

(30) Foreign Application Priority Data
Mar. 29, 2012 (DE) 102012205046.9

(51) Int. Cl. H01B 3/40; H01B 13/08; H02K 3/30

(52) U.S. Cl. CPC H01B 3/40; H02K 3/30; H01B 13/0891
USPC 523/458; 523/400; 523/466; 523/457; 29/887

(57) ABSTRACT

An electrical insulation body for a high-voltage rotary machine is provided. The electrical insulation body has a synthetic resin which is produced by reacting an epoxy with a hardener, and to which a filler component comprising particles is added, wherein the mass fraction of chlorine in the epoxy is less than 100 ppm.

### CROSS REFERENCE TO RELATED APPLICATIONS

This application is the US National Stage of International Application No. PCT/EP2013/052049 filed Feb. 1, 2013, and claims the benefit thereof. The International Application claims the benefit of German Application No. DE 102012205046.9 filed Mar. 29, 2012. All of the applications are incorporated by reference herein in their entirety.

### FIELD OF INVENTION

The invention relates to an electrical insulation body for a high-voltage rotary machine and a method for producing the electrical insulation body.

### BACKGROUND OF INVENTION

Electrical machines such as e.g. motors and generators have electrical conductors, an electrical insulation system and a stator core stack. The purpose of the insulation system is to electrically insulate the conductors from each other, from the stator core stack and from the environment. Sparks may occur due to partial electrical discharges during operation of the electrical machine and said sparks can form so-called “treeing” channels in the insulation. Said treeing channels may result in a dielectric breakdown of the insulation. A barrier against the partial discharges is provided by including mica in the insulation, mica being highly resistant to partial discharges. The mica is used in the form of flakes of mica particles having a normal particle size of several 100 micrometers to several millimeters, said mica particles being processed to produce a mica paper. A tape is used for greater strength and ease of processing, the mica paper being adhered to a substrate by means of an adhesive for this purpose.

In order to produce the insulation system, the tape undergoes further processing in a so-called VPI process (Vacuum Pressure Impregnation). In the VPI process, the tape is wound around the conductors and then placed into a bath containing a synthetic resin. The tape is impregnated with the synthetic resin by means of a vacuum and subsequent pressurization. Cavities in the tape and between tape and conductors are therefore filled by the synthetic resin. The synthetic resin is then cured in a furnace by the addition of heat, thereby producing the insulation system. Only between 1% and 5% of the synthetic resin in the bath is used when producing an individual insulation system in this way, and therefore a long useful life of the synthetic resin in the bath is desirable.

In order to improve the resistance of insulation systems to partial discharge, use is customarily made of inorganic nanoscale particles which are dispersed in the synthetic resin in the bath. Disadvantageous here is that the nanoscale particles reduce the useful life of the synthetic resin in the bath. This is manifested in particular in a progressive polymerization of the synthetic resin, resulting in an increase in the viscosity of the synthetic resin. However, a low viscosity of the reaction resin is important for complete impregnation of the tape.

### SUMMARY OF INVENTION

An object of the invention is to provide an electrical insulation body for a high-voltage rotary machine and a method for producing said electrical insulation body, wherein said method can be performed easily and economically.

The electrical insulation body according to aspects of the invention for a high-voltage rotary machine comprises a synthetic resin which is produced by reacting an epoxy with a hardener, and to which a filler component comprising particles is added, characterized in that the mass fraction of chlorine in the epoxy is less than 100 ppm. Conventional commercially available epoxy usually has a mass fraction of chlorine of approximately 1000 ppm. Trials were conducted in which the epoxy was purified before the production of the electrical insulation body. It surprisingly emerged in this case that if the epoxy has a total chlorine content of less than 100 ppm, a mixture which comprises particles comprising the epoxy, the hardener and the filler component has a significantly higher storage stability than a mixture which comprises an epoxy having a normal mass fraction of chlorine of approximately 1000 ppm. The high storage stability is characterized in that the mixture can be stored for a long time before the production of the electrical insulation body, without polymerization of the synthetic resin occurring to such an extent that processing of the mixture to form the electrical insulation body becomes impossible. Prior removal of synthetic resin that has already prepolymerized is not necessary, and therefore the production of the electrical insulation body is economical.

The epoxy is preferably purified by means of recrystallization such that the mass fraction of chlorine in the epoxy is less than 100 ppm. For the purpose of recrystallization, the comminuted crystals of the epoxy are stirred in an organic solvent, whereby the chloride-containing impurities of the epoxy dissolve in the solvent. For the purpose of recrystallization, the epoxy can also be dissolved by heating and then crystallized out by cooling. However, other purification methods are also conceivable, e.g. purification by means of chromatography.

The epoxy is preferably an aromatic epoxy, in particular bisphenol a diglycidyl ether and/or bisphenol f diglycidyl ether. These two epoxies are also known as BADGE and BFDGE.

The hardener is preferably an anhydride, in particular methylhexahydrophthalic acid anhydride and/or hexahydrophthalic acid anhydride. However, a hardener made of an amine such as e.g. ethylenediamine may also be used. The anhydride is preferably purified such that the fraction of free acid in the anhydride is less than 0.1 percent by mass, in particular by means of distillation and/or chromatography. Progressive polymerization of the synthetic resin prior to the production of the electrical insulation body is likewise advantageously inhibited thereby.

The filler component preferably comprises inorganic particles, in particular particles comprising silicon dioxide, titanium dioxide and/or aluminum dioxide. Inorganic particles are advantageously highly resistant to partial discharges. The filler component preferably comprises nanoscale particles, in particular having an average particle diameter of less than 50 nm. Nanoscale particles have a large surface, such that a multiplicity of solid-solid interfaces form in the electrical insulation body, thereby significantly increasing the resistance of the electrical insulation body to partial discharges. The mass fraction of the filler component relative to the synthetic resin is preferably 15 to 30 percent by mass, in particular 22 to 24 percent by mass. The electrical insulation body preferably comprises an insulation paper, in particular an insulation paper comprising mica, and the insulation paper is preferably saturated by the synthetic resin. The insulation paper may also be adhered to a substrate by means of an adhesive, such that the insulation paper has greater mechanical strength which is also better for processing.

The method according to aspects of the invention for producing an electrical insulation body comprises steps as follows: preparing a synthetic resin which comprises an epoxy and a hardener, and to which a filler component comprising particles is added, wherein the mass fraction of chlorine in the epoxy is less than 100 ppm; winding an insulation paper around an electrical conductor; saturating the insulation paper with the synthetic resin, whereby the synthetic resin and the particles are distributed in the insulation paper; finishing the electrical insulation body.

The saturation of the electrical insulation body can only be effected if the viscosity of the synthetic resin is less than a certain threshold value. By virtue of the mass fraction of chlorine in the epoxy being less than 100 ppm, the synthetic resin can be stored for a long time period without said threshold value being exceeded. Therefore the method can advantageously be performed easily and economically. It is moreover possible to prevent any sudden polymerization of the synthetic resin, this being highly exothermic and therefore representing a significant safety hazard.

The finishing of the insulation body preferably comprises reacting the epoxy with the hardener, thereby curing the synthetic resin. The reaction of the epoxy in the hardener is produced in particular by providing a catalyst, in particular zinc naphthenate, which is provided in the region of the insulation paper. As a result of this, polymerization of the synthetic resin preferably takes place in the region of the insulation paper.

The epoxy is preferably purified by means of recrystallization such that the mass fraction of chlorine in the epoxy is less than 100 ppm. The epoxy is preferably an aromatic epoxy, in particular bisphenol a diglycidyl ether and/or bisphenol f diglycidyl ether. The hardener is preferably an anhydride, in particular methylhexahydrophthalic acid anhydride and/or hexahydrophthalic acid anhydride. The anhydride is preferably purified such that the fraction of free acid in the anhydride is less than 0.1 percent by mass, in particular by means of distillation and/or chromatography. The filler component preferably comprises inorganic particles, in particular particles comprising silicon dioxide, titanium dioxide and/or aluminum dioxide. The filler component preferably comprises nanoscale particles, in particular having an average particle diameter of less than 50 nm. The mass fraction of the filler component relative to the synthetic resin is preferably 15 to 30 percent by mass. The insulation paper preferably comprises mica.

### BRIEF DESCRIPTION OF THE DRAWINGS

The invention is explained in greater detail below with reference to the appended schematic drawings, in which:

FIG. 1 shows a reaction scheme of a polymerization of a synthetic resin,

FIG. 2 shows a diagram comparing viscosities of a synthetic resin with and without nanoscale particles,

FIG. 3 shows a diagram comparing useful lives of electrical insulation bodies with and without nanoscale particles, and

FIG. 4 shows a diagram comparing viscosities of various mixtures of the synthetic resin.

### DETAILED DESCRIPTION OF INVENTION

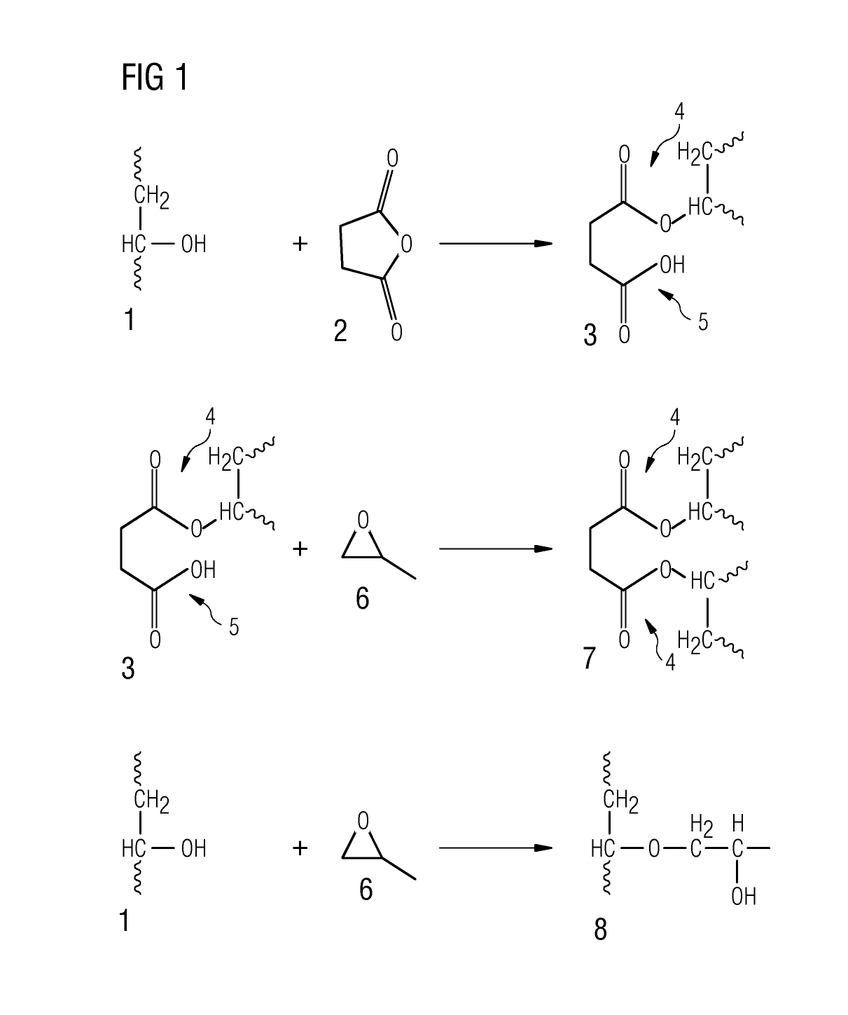

With reference to three chemical reactions, FIG. 1 illustrates the manner in which polymerization of a synthetic resin can occur, said synthetic resin comprising an epoxy and an anhydride. FIG. 1 shows a first reaction of a secondary alcohol 1, which may be produced as a result of the ring opening of an epoxy, with an anhydride 2. The reaction results in the formation of a semi-ester 3 comprising an ester group 4 and a carboxyl group 5. In a second reaction, the reaction of the semi-ester 3 with an oxiran group 6 of an epoxy resin is illustrated. The hydroxyl group of the carboxyl group 5 attacks the oxiran group 6 of the epoxy resin nucleophilically, whereby the oxiran ring is opened. An ester group 4 is now likewise produced from the carboxyl group 5. The resulting ester 7 having two ester groups 4 can further react with further anhydride molecules or oxiran groups. In a further possible third reaction, the secondary alcohol 1 can react with the oxiran group 6 of the epoxy resin. The secondary alcohol 1 likewise attacks the oxiran group nucleophilically with its hydroxyl group, thereby producing a 13 hydroxy ether 8 with ring opening of the oxiran ring.

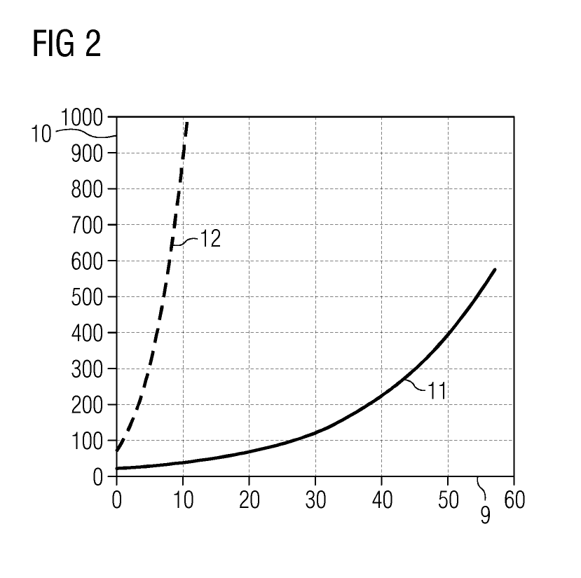

FIG. 2 illustrates a viscosity curve of two different synthetic resins. The storage time of the synthetic resin in days at a temperature of 70° C. is plotted on the x-axis 9 while the viscosity in mPas (milli-pascal seconds) at a storage temperature of likewise 70° C. is plotted on the y-axis 10. The viscosity curve of a synthetic resin without nanoscale particles 11 and the viscosity curve of a synthetic resin with nanoscale particles 12 are plotted. Both synthetic resins comprise a mixture of BADGE and an anhydride in this case. The mass fraction of nanoscale particles relative to the synthetic resin is 23 percent by mass in this case. Both viscosity curves 11, 12 are characterized by a non-linear increase in the viscosity as a function of the time. The initial viscosity of the synthetic resin without nanoscale particles at the time zero point is from 20 to 23 mPas in this case, while the initial viscosity of the synthetic resin with nano scale particles is approximately 80 mPas. It can be seen that the viscosity curve 12 rises much more steeply and rapidly than the viscosity curve 11 in this case. For example, a viscosity of 400 mPas is achieved after 5 days in the case of the viscosity curve 12, but after 50 days in the case of the viscosity curve 11.

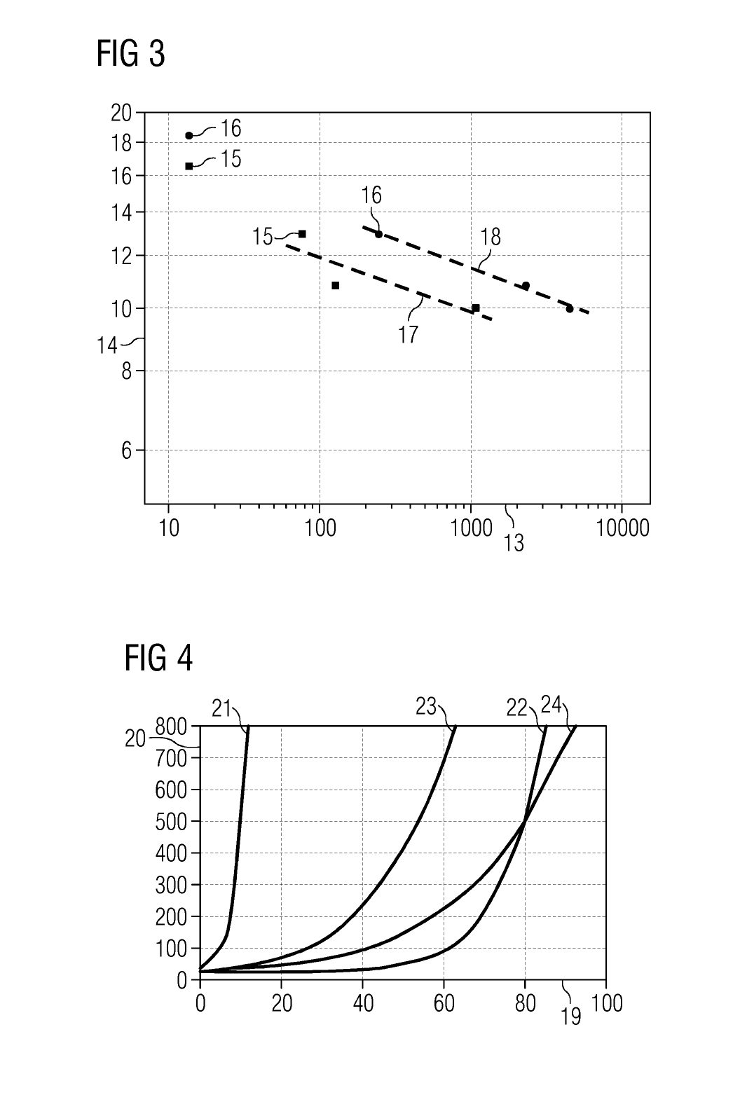

FIG. 3 shows a comparison between useful lives of electrical insulation bodies without nanoscale particles 15 and electrical insulation bodies with nanoscale particles 16. For this purpose, seven test pieces were each subjected to different field strengths ranging from 10 to 13 kV/mm. In order to determine the useful lives in a shorter time period, these field strengths are significantly higher than those occurring in conventional electrical machines. In this case, the useful life is the time which elapses while exposed to a field strength before a dielectric breakdown of the test piece occurs. In FIG. 3, the useful life in hours is plotted on the x-axis 13 and the field strength in kV/mm is plotted on the y-axis 14. The average useful lives of the seven test pieces are plotted in each case. The measured values of the electrical insulation bodies without nanoscale particles 15 were evaluated by means of a linear adaptation 17, and the measured values of the electrical insulation bodies with nanoscale particles 16 were evaluated by means of a linear adaptation 18. In this case, it is evident that the linear adaptations 17, 18 have essentially the same gradient and that the useful lives of the electrical insulation bodies with nanoscale particles 16 are five to ten times longer than the useful lives of the electrical insulation bodies without nanoscale particles 15.

FIG. 4 shows respective viscosity curves for four different mixtures of synthetic resins. The storage time of the synthetic resin in days at a storage temperature of 70° C. is plotted on the x-axis 19, and the viscosity in mPas at a temperature of likewise 70° C. is plotted on the y-axis 20. The first mixture is a synthetic resin which is filled with nanoscale particles, the second mixture is an unfilled synthetic resin. The third mixture is a synthetic resin which is filled with nanoscale particles and the surfaces of the particles are silanized, and the fourth mixture is a synthetic resin which is filled with nanoscale particles and the surfaces of the particles are silanized and the epoxy is purified such that the chlorine content in the epoxy is less than 100 ppm relative to the epoxy. The silanization of the surfaces reduces the number of hydroxyl groups on the surfaces. In this case, the silanization of the surfaces can be achieved by reacting the particles with methyltrimethoxysilane, dimethyldimethoxysilane and/or trimethylmethoxysilane. In all four mixtures, the viscosity increases non-linearly as a function of the time. It is obvious that the viscosities increase considerably more slowly in the case of those mixtures with silanized surfaces of the nanoscale particles, than in the case of the first mixture, which does not have silanized surfaces of the nanoscale particles. It is evident from FIG. 4 that the viscosity curve of the first mixture 21 increases considerably more quickly than that of the other three mixtures. The viscosity curves of the second mixture 22 and the fourth mixture 24 are similar, while the viscosity curve of the third mixture 23 lies between those of the first mixture and the third and fourth mixtures.

The invention is explained in greater detail below with reference to an example.

For example, the method for producing an electrical insulation body can be performed as follows: BADGE is purified by means of recrystallization such that the mass fraction of chlorine in the BADGE is less than 100 ppm. MHHPA is purified by means of distillation such that the fraction of free acid in the MHHPA is less than 0.1%. A filler component comprising particles is added to the BADGE. If the particles are present in a dispersion in a dispersant, the dispersion is mixed with the purified BADGE and the dispersant is then removed, e.g. by distillation. In the next step, a stoichiometric mixture is produced from the BADGE and the MHHPA, thereby producing a synthetic resin, wherein the mass fraction of the filler component is 23 percent by mass relative to the synthetic resin. The particles are nanoscale particles having an average particle size of less than 50 nm and consist of silicon dioxide. Before the nanoscale particles are added to the BADGE, the surfaces of the nanoscale particles are modified by reacting the nanoscale particles with methyltrimethoxysilane. An insulation paper comprising mica is wound around an electrical conductor. The insulation paper is adhered to a substrate by means of an adhesive for greater strength. The insulation paper and the substrate are together impregnated with the synthetic resin by means of a VPI process. The synthetic resin is cured and the electrical insulation body is finished.

Although the invention is illustrated and described in detail above with reference to the preferred exemplary embodiment, the invention is not restricted by the examples disclosed herein and other variations may be derived therefrom by a person skilled in the art without thereby departing from the scope of the invention.

1.-19. (canceled)

20. An electrical insulation body for a high voltage rotary machine, comprising:
a synthetic resin which is produced by reacting an epoxy with a hardener, and to which a filler component comprising particles is added,
wherein the mass fraction of chlorine in the epoxy is less than 100 ppm.

21. The electrical insulation body as claimed in claim 1, wherein the epoxy is purified by means of recrystallization such that the mass fraction of chlorine in the epoxy is less than 100 ppm.

22. The electrical insulation body as claimed in claim 1, wherein the epoxy is an aromatic epoxy.

23. The electrical insulation body as claimed in claim 1, wherein the hardener is an anhydride.

24. The electrical insulation body as claimed in claim 23, wherein the anhydride is purified such that the fraction of free acid in the anhydride is less than 0.1 percent by mass.

25. The electrical insulation body as claimed in claim 1, wherein the filler component comprises inorganic particles.

26. The electrical insulation body as claimed in claim 1, wherein the filler component comprises nanoscale particles.

27. The electrical insulation body as claimed in claim 1, wherein the mass fraction of the filler component relative to the synthetic resin is 15 to 30 percent by mass.

28. The electrical insulation body as claimed in claim 1, wherein the electrical insulation body comprises an insulation paper and the synthetic resin saturates the insulation paper.

29. A method for producing an electrical insulation body comprising:
preparing a synthetic resin which comprises an epoxy and a hardener, and to which a filler component comprising particles is added, wherein the mass fraction of chlorine in the epoxy is less than 100 ppm;
winding an insulation paper around an electrical conductor;
saturating the insulation paper with the synthetic resin, whereby the synthetic resin and the particles are distributed in the insulation paper; and
finishing the electrical insulation body.

30. The method as claimed in claim 29, wherein the finishing of the electrical insulation body comprises reacting the epoxy with the hardener, whereby the synthetic resin is cured.

31. The method as claimed in claim 29, wherein the epoxy is purified by means of recrystallization such that the mass fraction of chlorine in the epoxy is less than 100 ppm.

32. The method as claimed in claim 29, wherein the epoxy is an aromatic epoxy.

33. The method as claimed in claim 29, wherein the hardener is an anhydride.

34. The method as claimed in claim 33, wherein the anhydride is purified such that the fraction of free acid in the anhydride is less than 0.1 percent by mass.

35. The method as claimed in claim 29, wherein the filler component comprises inorganic particles.

36. The method as claimed in claim 29, wherein the filler component comprises nanoscale particles.

37. The method as claimed in claim 29, wherein the mass fraction of the filler component relative to the synthetic resin is from 15 to 30 percent by mass.

38. The method as claimed in claim 29, wherein the insulation paper comprises mica.

39. The electrical insulation body as claimed in claim 22, wherein the aromatic epoxy comprises bisphenol a diglycidyl ether and/or bisphenol f diglycidyl ether.

40. The electrical insulation body as claimed in claim 23, wherein the anhydride comprises methylhexahydrophthalic acid anhydride and/or hexahydrophthalic acid anhydride.

41. The electrical insulation body as claimed in claim 24, wherein the anhydride is purified by distillation and/or chromatography.

42. The electrical insulation body as claimed in claim 25, wherein the inorganic particles comprise silicon dioxide, titanium dioxide and/or aluminum dioxide.

43. The electrical insulation body as claimed in claim 26, wherein the nanoscale particles have an average particle diameter of less than 50 nm.

44. The electrical insulation body as claimed in claim 28, wherein the insulation paper comprises mica.

45. The method as claimed in claim 32, wherein the aromatic epoxy comprises bisphenol a diglycidyl ether and/or bisphenol f diglycidyl ether.

46. The method as claimed in claim 33, wherein the anhydride comprises methylhexahydrophthalic acid anhydride and/or hexahydrophthalic acid anhydride.

47. The method as claimed in claim 34, wherein the anhydride is purified by distillation and/or chromatography.

48. The method as claimed in claim 35, wherein the inorganic particles comprise silicon dioxide, titanium dioxide and/or aluminum dioxide.

49. The method as claimed in claim 36, wherein the nanoscale particles have an average particle diameter of less than 50 nm.
